(19) United States
(12) Patent Application Publication
(10) Pub. No.: US 2021/0172069 A1
(43) Pub. Date: Jun. 10, 2021

(54) COATING FOR STEEL, COATED STEEL AND A METHOD OF THE SAME

(71) Applicant: MAGNA INTERNATIONAL INC., Aurora (CA)

(72) Inventors: Jeremiah John BRADY, Knoxville, TN (US); Edward Karl STEINEBACH, Oak Ridge, TN (US); Richard Lee WINFREE, Knoxville, TN (US); Vinod Kumar SIKKA, Oak Ridge, TN (US); Kenneth Ray ADAMS, Oakland Township, MI (US)

(21) Appl. No.: 16/614,038

(22) PCT Filed: May 16, 2018
(86) PCT No.: PCT/US2018/032963

§ 371 Date: Nov. 15, 2019

Related U.S. Application Data
(60) Provisional application No. 62/508,123, filed on May 18, 2017.

(51) Int. Cl. C23C 28/02; C23C 22/02; C23C 10/02; C23C 10/50; C23C 10/58; C23C 24/08

(52) U.S. Cl. CPC C23C 28/021; C23C 22/02; C23C 24/087; C23C 10/50; C23C 10/58; C23C 10/02

(57) ABSTRACT

A coating process employing coating techniques which allow an end-user to coat steel, rather than relying on a specialized location or supplier, is provided. The techniques produce a coating having high temperature oxidation resistance, greater corrosion resistance, and added surface lubricity to minimize die wear during a stamping process. The techniques also allow configurability with surface textures and allow thickness control. In addition, selective coating of a part or product, for example, around a weld area, and the addition of componentry, for example sensors, with the sensors being employed to monitor the coating, is possible. The coating includes a top functional layer including least one of Al, Ni, Fe, Si, B, Mg, Zn, Cr, h-BN, and Mo, and an interfacial layer with intermetallics formed therein. The interfacial layer can consist of at least one intermetallic, or the interfacial layer can include a mixture of the intermetallic(s) and steel.

### CROSS REFERENCE TO RELATED APPLICATIONS

This PCT International Patent application claims the benefit of U.S. Provisional patent Application Ser. No. 62/508,123 entitled “Coating For Steel, Coated Steel And A Method Of The Same,” filed May 18, 2017, the entire disclosure of the application being considered part of the disclosure of this application, and hereby incorporated by reference.

### BACKGROUND

### 1. Field of the Invention

The invention relates generally to a component including a coating, such as a coated component for an automotive vehicle, and a method of manufacturing the coated component.

### 2. Related Art

Steel products, such as automotive vehicles, undergo coating processes to provide a finished product. Conventional, molten bath dip processes are employed. A molten bath dip process involves a dipping of a steel product to be coated into a molten bath.

However, this technique has several drawbacks. Due to the complex nature of the equipment required, an implementer has to invest considerable capital. Further, an entire steel area needs to be coated, and thus, a selected area cannot be coated. Further, the molten dip process requires that the coating occur at a specific location at which the molten dip processing equipment is located.

Additionally, due to the limitations of the molten dip process, steel coated with this technique may suffer from issues related to oxidation and corrosion resistance, lack of enough surface lubricity (to minimize die wear), lack of being painted easily; poor surface texture; not enough or controlled amounts of coating thickness; and may be incapable of augmentation with other peripherals (for example, surface sensors).

### SUMMARY

One aspect of the invention provides a component, for example a component for an automotive vehicle. The component comprises a substrate formed of steel or steel-based material, an interfacial layer disposed on the substrate, and a top functional layer disposed on the interfacial layer. The interfacial layer includes aluminum, and the top functional layer includes at least one of Al, Ni, Fe, Si, B, Mg, Zn, Cr, h-BN, and Mo. The interfacial layer also includes at least one intermetallic.

Another aspect of the invention provides a method of manufacturing a component, for example a component for an automotive vehicle. The method includes applying an interfacial layer to a substrate formed of steel or steel-based material. The interfacial layer is applied as a first slurry containing aluminum in the form of powder. The method further includes heating the interfacial layer to a temperature ranging from about 100 to about 600° C. after applying the interfacial layer to the steel substrate, and heating the interfacial layer to a temperature ranging from 600 to 954° C. after heating the interfacial layer to a temperature ranging from about 100 to about 600° C. The method also includes applying a top functional layer to the interfacial layer. The top functional layer is applied as a second slurry containing at least one of Al, Ni, Fe, Si, B, Mg, Zn, Cr, h-BN, and Mo in the form of powder. The method further includes heating the top functional layer to a temperature ranging from about 100 to about 600° C. after applying the top functional layer to the interfacial layer, and heating the top functional layer to a temperature ranging from 600 to 954° C. after heating the top functional layer to a temperature ranging from about 100 to about 600° C.

### BRIEF DESCRIPTION OF THE DRAWINGS

FIG. 1 illustrates steps of a method of manufacturing a component according to an example embodiment;

FIG. 2A is a cross-sectional view of the component including a substrate, an interfacial layer, a top functional layer, and intermetallics in the interfacial layer;

FIG. 2B is an enlarged view of a portion of FIG. 2A;

FIG. 2C is an enlarged view of a portion of FIG. 2B showing intermetallics in the interfacial layer;

FIG. 3 includes a plot of mass change as a function of heating temperature of coated steel samples according to example embodiments;

FIG. 4 includes a plot of mass change as a function of heating temperature of coated steel samples according to other example embodiments;

FIG. 5 is a table listing example compositions that can be used to form the interfacial layer of the coating according to example embodiments;

FIG. 6 is a table listing weight and thickness of the coating, including the interfacial layer and top functional layer after application and processing according to example embodiments;

FIG. 7 is a plot of the coating weight and thickness listed in FIG. 6;

FIG. 8 is a table listing compositions of slurries used to form the interfacial layer of the coating according to example embodiments;

FIG. 9 shows a coated substrate (panel) according to an example embodiment; and

FIG. 10 is a cross-sectional view showing the microstructure of a coated substrate according to an example embodiment.

### DETAILED DESCRIPTION OF EXAMPLE EMBODIMENTS

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

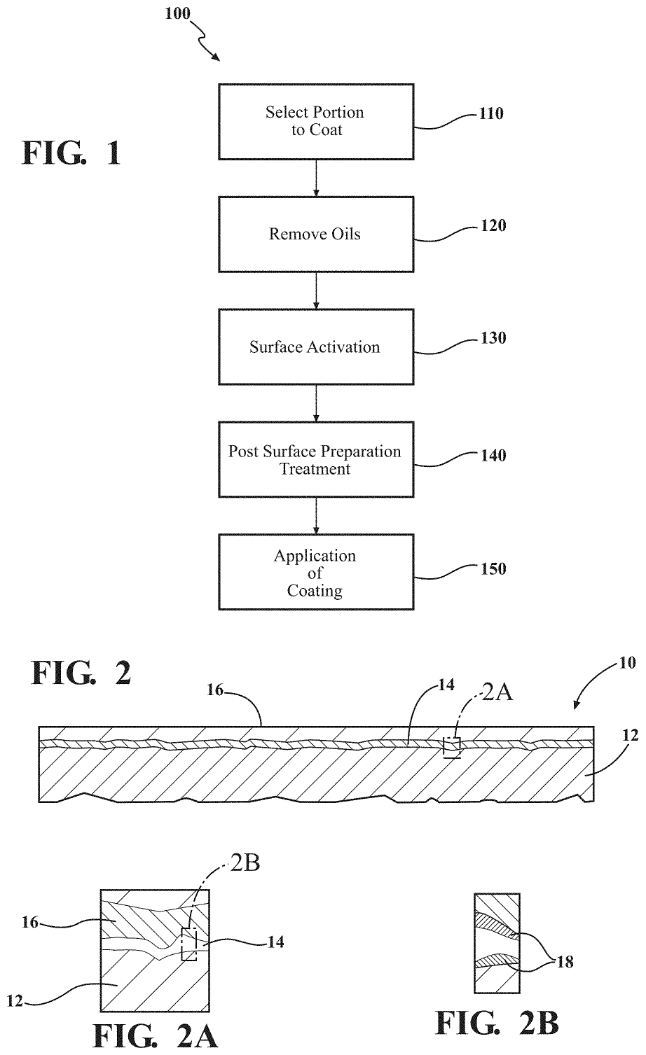

The aspects disclosed herein are directed to an improved coating process, for example the process disclosed in FIG. 1, that avoids many of the issues and problems laid out in the Background section. Thus, employing the disclosed coating techniques provides the following benefits:
1) Allowing an end-user to coat steel rather than relying on a specialized location or supplier;
2) Producing coating with high temperature oxidation resistance;
3) Providing greater corrosion resistance;
4) Adding surface lubricity to minimize die wear during stamping process;
5) Allowing configurability with surface textures;
6) Allowing thickness control (based on the amount of coating);
7) Selectively coating a part or product, for example, around a weld area; and
8) Allowing the addition of componentry, for example sensors, with the sensors being employed to monitor the coating.

Specifically, the aspects disclosed herein detail a surface coating process and resultant materials for application to steel and steel-based products. The new, innovative coating process allows the application and formation of a top functional surface with a controlled interfacial region.

To provide this process, various slurries including binders, suspending agents, dispersants, solvents, surfactants, flux agents, metal coating compositions are disclosed. In addition, the aspects disclosed herein are directed to pre-coating surface treatments, and applications of the interfacial and top. The coatings are provided with functional coatings that include a step-wise heat treatment.

There are several key aspects of producing coatings on steel substrates disclosed herein. The first is the surface preparation of the steel substrate should be performed so as to provide a good interface with good adhesion. In experiments, 0.1 to 1 molar of HCl solution has been shown to be very effective.

FIG. 2A illustrates an example of a component 10 employing the aspects disclosed herein. The component 10 includes a steel substrate 12, an interfacial layer 14, and a top functional layer 16. An enlarged view of a portion of the coated component 10 is shown in FIG. 2B. As shown in FIG. 2C, the component 10 includes interfacial gradients 18 between the substrate 12 and the core of the interfacial layer 14, and also between the core of the interfacial layer 14 and the top functional layer 16. The interfacial layer 14 and/or the gradients 18 can include intermetallics, which will be described further below. The interfacial layer 14 and/or the gradients 18 can consist of the intermetallic or intermetallics. Alternatively, the interfacial layer 14 and/or the gradients 18 can include a mixture of the intermetallic or intermetallics and an alloy of steel.

However, after the surface has been degreased and the oxide removed, application of the slurry should occur within a predefined time, and preferably, as soon as possible. According to the aspects disclosed herein, the slurry chemistry, composition, and deposition process and the control thereof is vital to getting a uniform, controlled, repeatable coating with a minimal amount of oxidation during a heat treatment.

In one example, the interfacial coating may be a slurry of the metal powders containing aluminum followed by deposition of the top functional coating as a slurry of metal powders containing corrosion resistant components. If these steps are pursued, the functional surface may be provided with the advantageous properties disclosed herein.

According to the aspects disclosed herein, a heat treatment is also performed, and specifically applied after deposition of the interfacial coating. The heat treatment is defined as a cure or bake at typically about 100-300° C. The result of this heat treatment is that solvents used in the process are removed, and subsequent high temperature processing (700-960° C.) is employed to form the coating.

The heat treatments are applied after deposition of the top functional coating, included heating at 100-300° C. (preferably at 200° C.) cause the evaporation and removal of the solvent used for the polymer carrier. After the first heat treatment, a second heat treatment may also occur at 700° C., 880° C., and 960° C. These heat treatments are followed by steel block quench, water quenching, or more preferably, a final forming process, such as hot stamping.

FIG. 1 illustrates an overview 100 of the process. In operation 110, a selected portion of the steel is determined to be coated. As mentioned above, employing the aspects disclosed herein, a coating process may be selectively chosen to be coated. Once a demarcated section of the steel is chosen, the remaining operations may be performed selectively on that portion.

It is important, prior to applying any sort of coating, that the surface be treated. As discussed below, and specifically with steps 120-140, this process may include the following steps elaborated herein. By preparing the steel substrate as such, a better adhesion may be obtained.

In operation 120, oils may be removed (or the surface may be degreased). For example, known degreasing techniques may be employed, such as solvents and alkali solutions, such as acetone and MEK. The solvents removed the majority of the oils, but further removal is accomplished by cleaning the surfaces with alkali solutions. These include the use of alkalis such as NaOH and KOH. Typical concentration of the alkali solutions is 1-5% by weight (wt %), based on the total weight of the solution. The alkali solutions work better if they are further modified by surfactants for improved wetting of the oily surfaces which have high water contact angels with reduced uniform wetting. It is also noted that the alkali oil removal action is further enhanced by using hot solutions at temperatures in the range of 125-175° F. (52-80° C.). Once the alkali solutions are used. It is critical that any excess is removed and it is accomplished by using clean water heated to 125-150° F. (52-80° C.).

In operation 130, surface activation is performed by a step of etching. After operation 120, the surface under the oily surface still may have a thin layer of surface oxide that needs to be removed for better bonding of the coatings to the steel surface. The surface activation may be accomplished by mechanical and chemical methods, such as those described below.

The mechanical methods include processes such as abrading lightly using scotch bright pads, wire brushes, blasting using alumina particles, sand particles or glass beads.

The chemical methods of activation include processes such acid etching, coatings consisting of zinc phosphate (which requires a pre-coat of titanium and a post coat of chromium coating to seal in the zinc phosphate).

After operation 120 and 130, the water vapor may still be adsorbed on the surface. This adsorbed layer needs to be removed before the coating application to make sure that during the post processing of coating at high temperatures, the adsorbed water can build pressure at the steel/coating interface, thereby causing the coating to be de-bonded. The best way to address this issue is to bake the surfaces that have been prepared to a predefined temperature (for example, 250° F., (121° C.), prior to the coating. The preheated surfaces also give the advantage of rapid drying of the coating when applied by spray or roll coating process.

In operation 150, the coating system according to the aspects disclosed herein is performed. The remaining portion of this disclosure will enumerate various combinations of coating. The aspects disclosed herein discuss a two-layer coating technique. The first layer (or interfacial layer), is directly adhered to the steel substrate (or the selective portions of the steel substrate). The second layer (or top layer) is applied after the interfacial layer.

The materials described herein preferably provide an inherent exothermic reaction to produce the coatings used for both layers. Thus, if the correct materials are chosen, the resultant material may be able to ignite based on either an application of heat through a propane torch, or a stimulant, such as magnesium metal powder. Based on the slurry applied, the resultant slurry may be selectively associated with a specific heating technique (such as those enumerated above, or others not mention). While the exothermic reaction is occurring, other elements may also be blended in to improve and customize the overall coating (see the discussion below with the binders listed).

Intermetallic phases are formed between the steel substrate and the top functional coating. The two-layer coating and application process can be used on steel of various compositions including 22MnB5 steel, providing a lubricious surface to reduce die wear and prevent oxidation and corrosion during and after component fabrication, at a lower cost, with an ease of application for the interfacial and top functional coating surfaces. The coatings of this disclosure applied to steel surfaces produces oxidation protection during heating and stamping processes, typically hot stamping but also produce oxidation protection during cold or room temperature stamping processes.

The novel coatings described herein use pre-coating surface treatments to allow a good interfacial adhesion between the coating boundaries, after the application of the coating by spray deposition of the slurry composition. The preparation of the steel may include degreasing, oxide removal, and/or surface roughening. The organic degreaser, using typical degreasing agents such as acetone and alcohols, is optional, etching of the steel surface using dilute to concentrated hydrochloric acid, 0.1 to 10 M, more preferably 0.1 to 1 M HCI, provides an oxide free or near oxide free surface and a rough surface with microscopic and macroscopic surface features that increase the chemical and mechanical adhesive interaction as well as increase surface area for interaction.

The substance used to coat the steel requires a use of a slurry according to the aspects disclosed herein. Specifically, the slurry may include one or more of the ingredients from the list of binders, suspending agents, dispersants, solvents, surfactants, and flux agents with metal coating compositions disclosed below. A flux is typically used unless an inert environment is provided. The inert environment can be an inert gas, such as argon, provided by an enclosure or inert gas shroud. The coatings can be deposited by a number of processes including spray, dip, brush, thermal spray techniques such as atmosphere plasma spray, vacuum plasma spraying, high velocity spraying (HVOF), flame spraying, wire arc spraying, core wire arc spraying, or physical vapor deposition (PVD), chemical vapor deposition (CVD), molten bath dip coating, slurry brush coating, slurry spray coating, and slurry dip coating. This list is not intended to cover all methods of applying the coatings but to provide representative examples. The composition and chemistry of the interfacial coating and of the top functional coating can be altered to provide a composite and/or gradient surface having the desired properties.

The slurry composition may incorporate an exothermic reaction concept for producing functional coatings that achieve improvements over existing coating techniques. The data shown in Table 1 presents exothermic reactions that are described herein. The order of the melting points for the intermetallic listed in the table are: NiAl (1639° C.)>Fe₃Al (1502° C.)>Ni₃Al (1395° C.)>FeAl (1215° C.)>Fe₂Al₅ (1171° C.)>FeAl₂ (1164° C.)>Ni₂Al₃ (1133° C.)>NiAl₃ (854° C.). Thus, for each system the melting point order is as: NiAl (1639° C.)>Ni₃Al (1395° C.)>Ni₂Al₃ (1133° C.)>NiAl (854° C.) and Fe₃Al (1502° C.)>FeAl (1215° C.)>Fe₂Al₅ (1171° C.)>FeAl₂ (1164° C.).

TABLE 1
Exotherms for Intermetallic Components.

| | Heat of Formation | Weight Percent of | Melting Point |
|---|---|---|---|
| Intermetallic | ΔH_{f298} (K cal/mol) | Aluminum | (° C.) |
| Ni₃Al | −36.6 ± 1.2 | 13.28 | 1395 |
| NiAl | −28.3 ± 1.2 | 31.49 | 1639 |
| Ni₂Al₃ | −67.5 ± 4.0 | 40.81 | 1133 |
| NiAl₃ | −36.0 ± 2.0 | 57.96 | 854 |
| Fe₃Al | −16.0 | 13.7 | 1502 |
| FeAl | −12.0 | 32.57 | 1215 |
| FeAl₂ | −18.9 | 49.1 | 1164 |
| Fe₂Al₅ | −34.3 | 54.70 | 1171 |

Relative to the heat of formation, the most favorable phase for the Ni—Al system is Ni₂Al₃ and for the Fe—Al system is Fe₂Al₅ according to the order as: Ni₂Al₃>Ni₃Al>NiAI>Fe₂Al₅>NiAl>FeAl₂>Fe₃Al>FeAl. Thus, for the Ni—Al system, the preferred, most favorable, or most probable order of formation is: Ni₂Al₃>Ni₃AI>NiAl₃>NiAl and for the Fe—Al system, the preferred, most favorable, or most probable order of formation is: Fe₂Al₅>FeAl₂>Fe₃Al>FeAl. Although the most probable component formed in the interaction of Ni and Al is Ni₂Al₃ which has a melting point of 1133° C., appreciable amounts of the Ni₃Al and NiAl phases also form. The most probable phase of the Fe—Al system is Fe₂Al₅, which has a relatively low melting point, whereas the FeAl phase has the highest melting point and a probability of formation equivalent to the FeAl₂, both somewhat lower probability of formation.

All of the slurries above are either Al or powders needed for gradient or composite coatings. The mediums in which these slurries may be includes with are, but not limited to, acetone, ethyl alcohol (or other alcohols), polyvinyl alcohol (PVA), propylene glycol, hydroxylpropylcellulose-water (HPC-H20), HPC in water and 91% isopropyl alcohol, HPC with polyvinylpyrrolidone (PVP) in water and 91% isopropyl alcohol, 98% water and 2% Mg-AI-silicate, styrene-butadiene rubber (S5R) or acrylonitriie-butadiene-styrene (ABS) in a colloid with dispersions such as polyvinyl acetate or vinyl acetate ethylene (VAE), or carboxylic methylcellulose-water (CMC-H20), Aqueous solutions or water and 91% isopropyl alcohol solutions of sodium lauryl sulfate (SLS). Specifically, the enumerated list above may be added as a surfactant to any of the slurries described herein.

As an example, a simple spray application of an Al-Acetone slurry as the interfacial coating can be applied on steel samples. The coating uniformity is apparent. An observation from these trials is that the powders are more easily spray deposited using very fine powders in the 5-25 micron range.

Applying the exotherm approach, slurries containing Al or Al with addition of one or more of the constituents Si (0.5 to 15 wt %), B (0.5 to 15 wt %), Mg (0.5 to 85 wt %), Zn (0.5 to 85 wt %), Ni (0.5 to 85 wt %) or other desired additions, based on the total weight of the slurry, allows curing the interfacial coating on steel substrates at 600° C. to 950° C., or more preferably 700° C. to 800° C. Interfacial coatings (first layer coating), can be spray deposited on steel substrates. For example, an Al acetone slurry can be deposited and cured by gas fired heating, or an Al acetone slurry can be deposited and cured at 954° C. for 5 minutes. Other examples include Al and Al—Zn coatings which have been cured using the gas fired heating method. Another example includes the deposition of an Al interfacial coating with a top Al coating after gas fired heating to cure and then furnace heating at 954° C. for 5 minutes. The gas firing oven heats more effectively around the center of the coupon. In the approach, Al (and some of the other ingredients) will melt during the heat treatments for the formation or initial formation of the intermetallic phases.

An example of the exotherm approach (which is exemplified in the table above) is as follows. When, Al and Fe are heated to a certain temperature, the formation of Fe—Al intermetallic release a large amount of heat that helps fuse the coating of element(s) selected to the base metal (steel). This way the steel is used in two ways. First as an element to cause the exothermic reaction, and another as the base for fusing the chosen elements to.

There are several slurry compositions selections that can be used with the added metal and metal alloy constituents, with or without surfactants (sodium lauryl sulfate, etc.) and/or flux agents (boric acid, calcium fluoride, etc.). The following present a few examples of the interfacial coatings produced on steel by the use of slurries:
1) Slurry spray painting of Al-6Si powders blended in acetone with and without with and without previously described surfactants and flux agents,
2) Slurry spray painting of Al-6Si powders blended in ethyl alcohol with and without with and without previously described surfactants and flux agents,
3) Slurry spray painting of Al-6Si powders blended in methylethylketone (MEK) with and without with and without previously described surfactants and flux agents,
4) Slurry spray painting of Al-5Si powders blended in polyvinylalcohol-water (PVA-H20) with and without with and without previously described surfactants and flux agents,
5) Slurry spray painting of Al-6Si powders blended in carboxylic methylcellulose-water (CMC-H20) binder with and without with and without previously described surfactants and flux agents,
6) Slurry spray painting of Al-6Si powders blended in Hydroxypropyl cellulose (HPC) with and without with and without previously described surfactants and flux agents,
7) Slurry spray painting of Al-6Si powders blended in Hydroxypropyl cellulose (HPC) with polyvinylpyrrolidone (PVP) In water and 91% isopropyl alcohol,
8) Slurry spray painting of Al-6Si powders blended in Hydroxypropyl cellulose (HPC) with polyvinylpyrrolidone (PVP) and boric acid (8A) in water and 91% isopropyl alcohol,
9) Slurry spray painting of Al-6Si powders blended in Hydroxypropyl cellulose (HPC) with polyvinylpyrrolidone (PVP), boric acid (BA), and sodium lauryi sulfate (SLS) in water and 91% Isopropyl alcohol,
10) Slurry spray painting of Al-6Si powders blended in SBR (styrene butadiene rubber) Precursor Latex emulsion with and without surfactants and flux agents,
11) Slurry spray painting of Al-6Si powders blended in VAE, a vinyl acetate/ethylene (VAE) emulsion suspending agent, and boric acid (6A) in water,
12) Slurry spray painting of Al-6Si powders blended in VAE, a vinyl acetate/ethylene (VAE) emulsion suspending agent, boric acid (BA), and sodium lauryi sulfate (SLS), in water.

Steel coupons were dip coated in a slurry of Al powders blended in SBR with and without the sodium lauryl sulfate (SLS). For example, the component can include an Al interfacial coating, with and without the SLS, cured at 400° C. to evaporate and remove the binder followed by heat treatments at 700° C., 880° C., and 930° C., and water quenching.

In another example, steel coupons were brush coated with a slurry of Al-3.3Si-3.4BN in the suspension agent VAE with 9.6% BA added as a flux. The slurry was vigorously stirred before application with a brush. The steel coupons were first degreased plated with acetone, etched with 1.33 M HCI to remove surface oxide, rinsed with water, rinsed with acetone, dried, and immediately coated by brush application. The coated steel coupons were cured at 400° C. to evaporate and remove the tender followed by heat treatments at 700° C., 880° C., and 930° C.

An example of the interfacial layer is the slurry spraying of aluminum (Al) or aluminum-3-15 wt % Si (Al-3Si to Al-15Al), more preferably Al-6Si, applied to steel after surface preparation by etching using −1M HCI solution. There are a number of slurry preparation methods as outlined below. An example is the mixing of the first layer component, such as Al-6Si, in acetone, ethyl alcohol, polyvinyl alcohol, or propylene glycol to a spray paint viscosity. After which, the coating is applied by one of the deposition processes, such as spraying, onto the surface which has been prepared by degreasing and/or etching.

The powder, such as the Al-6Si, is mixed with a liquid suspension medium, or carrier, to form a slurry. The liquid carrier may include alcohol, a water-alcohol mixture, an alcohol-ethylacetoacetate mixture, acetone, an alcohol-acetone mixture, polyvinyl alcohol-water mixture, or propylene glycol, to name just a few. The carrier is typically evaporated during the coating curing process. A number of commercially-available suspension media can be used, such as hydroxylpropylcellulose (HPC), or several other carrier mediums manufactured that are 98% water and 2% Mg—Al-silicate medium.

For some applications, a low melting temperature binder is added to the coating mixture. Typically, the binder material, like the carrier, is lost during the curing process. In other instances, the binder may remain in the cured coating, acting as a matrix material. Additional components for controlling physical characteristics of the slurry, such as surface active agents, or surfactants, such as sodium lauryl sulfate, polyvinyl alcohol, and carbowax, may be added to maintain suspension of the solid phase. Lubricants, such as stearic acid, may be added to assist in consolidation of the slurry components. A low melting temperature metallic binder, such as a solder or braze alloy, can be added to the coating mixture—metallic matrix may be incorporated when a ceramic component in the coating is being applied to a metal workpiece surface, where the metallic binder has a melting point below the melting point of the coating powder and the workpiece material and upon melting, the metallic matrix wets the workpiece surface and wets/embodies the coating powder particles forming a metallic matrix having a hard reinforcement material formed therein.

An example is a powder containing 13.8 wt % nickel-aluminum alloy binder blended in 50 wt % HPC media or 98% water, and 2% Mg—Al-silicate.

In some cases, powders are blended together with a binder powder/suspension agent, stirred into an alcohol or another volatile organic and rolled, milled, and mixed for several hours, typically from 1 to 24 hours, to improve mixture uniformity. The slurry is painted or sprayed onto the substrate surface and dried, either at room temperature overnight or by heating at 50 to 90° C. for a few minutes. The coating is then baked typically at about 100 to 600° C. to remove the binder and subsequently processed to form the coating.

In another example, the powder mixture containing SiC whiskers is blended together with polyvinylpyrrolidine binder powder, stirred into methanol and rolled, milled, and mixed for several hours, typically from 1 to 24 hours, to improve mixture uniformity. The slurry is painted or sprayed onto the substrate surface and dried, either at room temperature overnight or by heating to 50 to 90° C. The coating is then baked typically at about 100-600° C. to remove the binder and subsequently processed to form a SiC whisker reinforced coating. The whiskers are like hairs, they are particles with 3 to 10× longer length as compared to their short dimensions. Such whiskers can make the metallic coating very strong and can even give directional properties if the whiskers are aligned during the application process.

In another example, the powder mixture is blended together with boric acid and binder powder, stirred into methanol and rolled, milled, and mixed for several hours, typically from 1 to 24 hours, to improve mixture uniformity. The slurry is painted or sprayed onto the substrate surface and dried, either at room temperature overnight or by heating to 50 to 90° C. The coating is then baked typically at about 100-600° C. to remove the binder and subsequently processed to form the whisker reinforced coating.

In another case, the powder mixture is blended together with HPC or hydroxypropylcellulose as a binder powder/suspension agent, stirred into methanol and rolled, milled, and mixed for several hours, typically from 1 to 24 hours, to improve mixture uniformity. The slurry is painted or sprayed onto the substrate surface and dried, either at room temperature overnight or by heating to 50 to 90° C. The coating is then baked typically at about 100-600° C. to remove the binder and subsequently processed to form the whisker reinforced coating.

In another example, aluminum powder and silicon powder, typically from 0.5 to 15 wt % Si, are blended into a colloidal ceramic suspension, such as colloidal silica (colloidal ceramic oxides include silica, alumina, yttria, zirconia, etc.). The concentration can be varied from a few percent (1 to 2 wt %) to a high concentration of aluminum powder and silicon powder particles (99 wt %), but typically between 20 to 80 wt %, and more preferably 30 wt %.

In another example, styrene-butadiene rubber (SBR) or acrylonitrile-butadiene-styrene (ABS) in a colloid with dispersions such as polyvinyl acetate or vinyl acetate ethylene (VAE) in an aqueous medium are blended with the metal powders. Polyvinyl alcohol (PVA), a water-soluble synthetic polymer can be added to make polyvinyl acetate dispersions. Water-soluble polymers, such as certain PVA or hydroxyethylcellulose (HPC), can also be used to act as emulsifiers/stabilizers. The final product is a dispersion of polymer particles in water, also be known as a polymer colloid, a latex. The emulsion with the metal powders can be used in batch, semi-batch, or continuous processes. The selection of the surfactant is critical to the emulsion process to minimize coagulation. Examples of surfactants commonly used in emulsion polymerization include fatty acids, sodium lauryl sulfate, or alpha olefin sulfonate.

Another preferred result of the aspects disclosed herein is the exothermic nature of the coating formation process. An exothermic coating results from a chemical or physical reaction that releases heat and providing energy to its surroundings. The exothermic nature is inherent to the coating process due to the exothermic reaction between the components of the top functional coating and the substrate, such as aluminide phases. Typical components result from the Al in the interfacial coating and the Fe in the substrate and Ni in the top functional coating. The phases formed can include iron aluminides, nickel aluminides, and/or titanium aluminides, as well as transition metal silicides. The exothermic process leads to an improved coating adhesion.

In some cases, the thermite process is inherent in the coating to create brief bursts of high temperature in a very small area to promote intermetallic formation. The thermite process includes a fuel and an oxidizer. When initiated by heat, the thermite undergoes an exothermic reduction-oxidation reaction, and the exothermic reduction can aid in the formation of intermetallic phases. To provide a thermite process in the coating substrate interaction, certain components include Al, Mg, Tl, Zn, Si, and B as fuels and bismuth oxide (Bi₂O₃), boron oxide (B₂O₃), silicon oxide (SiO₂), chromium oxide (Cr₂O₃), manganese oxide (MnO₂), iron oxide (Fe₂O₃), iron oxide (FeO), and copper oxide (CuO) as oxidizers. The slurry and the other coating layers may include some or all of the fuels and oxidizers to facilitate a thermite reaction to aid in the formation of the intermetallic phases. A thermite reaction between iron oxide and aluminum, which can occur if there is any residual surface oxide on the steel substrate, allows the formation of alumina, iron, and iron aluminide phases. The presence of FeAl₂O₄ and Al₂O₃ increased the surface hardness of the coating, and the hardness of the coatings is significantly higher than the hardness of steel substrate and aluminum particles.

Additional key aspects of coatings on steel include the binder to metal ratio, metal powder particle size, coating compositions, and surfactants, flux agents, and additives. The binder can range from 5 wt % to 95 wt %, but more preferably from 5 wt % to 15 wt %, by weight of the total blend. In some cases, the slurry is further diluted with water or 5% boric acid solution to a consistency that is easy to spray and when deposited and cured to provide the desired coating thickness on the finished steel components. The metal powder particle size can range from submicron to 100 microns, preferably 5 to 40 microns, more preferably from submicron to 20 microns, and most preferably from 2 to 7 microns, to provide a slurry more optimized for spray depositions. The content of the metal powders added to the slurry should contain aluminum to promote formation of intermetallic, such as Fe—Al, phases to promote coating adhesion. The composition can be adjusted to control the percentage of high temperature intermetallic phases between 1 to 95 wt %, preferably 5 to 40 wt %, more preferably from 1 to 20 wt %, and most preferably from 2 to 7 wt %, based on the total weight of the coating including all layers, to allow welding of the steel substrates. In addition to Al in the interfacial layer, other elements in the interfacial layer may include boron (B), zinc (Zn), silicon (Si), tin (Sn), magnesium (Mg), nickel (Ni), and iron (Fe) powders, ranging up to 20 wt % of the interfacial layer. The top functional coating may include Al, Ni, Fe, Si, B, Mg, Zn, chromium (Cr), hexagonal boron nitride (h-BN), molybdenum (Mo), individually or as an alloy. As an example, the top functional coating can be deposited having a composition of Ni—Cr—Al—Si—BN or Ni—Cr—Al—Si— Mo. The addition of Cr increases the corrosion resistance of coating. Mo can be added as pure Mo or as an alloy of Ni, Cr, or Fe. Any component, previously presented in the known art as lubricants, can be added or blended in the place of h-BN or Mo, added as lubricants for the formation of a lubricious surface.

Flux agents may be added to minimize or eliminate oxidation of components during heating treatments or process heating during fabrication. Typical flux agents which may be added to the coating composition include calcium fluoride (CaF₂), boric acid, and other known in the art. Flux agents refer to materials that contain elements for dissolving oxides, facilitating wetting of the substrate by the coating. Coatings which are not self-fluxing typically must be treated in a special atmosphere to prevent oxidation. The absence of a fluxing element hinders wetting to the substrate. The self-fluxing alloys are certain materials that wet the substrate and coalesce when heated to their melting point, without the addition of a fluxing agent. Self-fluxing alloys usually contain temperature suppressants such as boron and/or silicon. Si in conjunction with B has self-fluxing characteristics, but in the coatings as a matrix element, Si is a potential promoter of intermetallic precipitates, and has a major influence on the wear properties of the alloys. B content influences the level of Si required for any silicide (Ni₃Si) formation. The higher the B content, a lower amount of Si content is required to form silicides. Boride dispersions within the microstructure lead to excellent abrasion resistance, with low stress abrasion resistance generally increasing with B contents. The B content typically ranges from 1.5 to 3.5 wt %, depending on the Cr content which is up to about 16 wt %, based on the total weight of the composition.

The following present a few examples of the interfacial coatings produced on steel by the use of slurries:
1) Slurry spray painting of Al-6Si powders blended in acetone with and without previously described surfactants and flux agents,
2) Slurry spray painting of Al-6Si powders blended in ethyl alcohol with and without previously described surfactants and flux agents,
3) Slurry spray painting of Al-6Si powders blended in carboxylic methylcellulose-water (CMC-H₂O) binder with and without previously described surfactants and flux agents,
4) Slurry spray painting of Al-6Si powders blended in Hydroxypropyl cellulose (HPC) with and without previously described surfactants and flux agents,
5) Slurry spray painting of Al-6Si powders blended in Hydroxypropyl cellulose (HPC) with polyvinylpyrrolidone (PVP) in water and 91% isopropyl alcohol,
6) Slurry spray painting of Al-6Si powders blended in Hydroxypropyl cellulose (HPC) with polyvinylpyrrolidone (PVP) and boric acid (BA) in water and 91% isopropyl alcohol,
7) Slurry spray painting of Al-6Si powders blended in Hydroxypropyl cellulose (HPC) with polyvinylpyrrolidone (PVP), boric acid (BA), and sodium lauryl sulfate (SLS) in water and 91% isopropyl alcohol,
8) Slurry spray painting of Al-6Si powders blended in SBR (styrene butadiene rubber) Precursor Latex emulsion with and without surfactants and flux agents,
9) Slurry spray painting of Al-6Si powders blended in VAE, a vinyl acetate/ethylene (VAE) emulsion suspending agent, and boric acid (BA) in water,
10) Slurry spray painting of Al-6Si powders blended in VAE, a vinyl acetate/ethylene (VAE) emulsion suspending agent, boric acid (BA), and sodium lauryl sulfate (SLS), in water.

Thus, employing the aspects disclosed herein, including the method described in FIG. 1 and the composition of slurries and binders enumerated above, a coating process may achieve all of the advantages listed above and avoid the problems listed in the Background section.

The proposed coating of this disclosure includes a binder system and a solvent system to incorporate the binder system and selected metal and alloy combinations and potential activators. These aspects will be described with greater detail below.

The new binding systems chosen for this invention are styrenic block copolymer (SBC) consisting of polystyrene blocks and rubber blocks. The rubber blocks consist of polvbutadiene, polvisoprene or their hydrogenated equivalents. The tri-block with polystyrene blocks at both extremities linked together by a rubber block is the most important polymer structure observed in SBC. If the rubber block consists of polybutadiene, the corresponding triblock structure is: poly(styrene-block-butadiene-block-styrene) usually abbreviated as SBS. These copolymers are called Kraton polymers. The Kraton D (SBS and SIS) and their selectively hydrogenated versions Kraton G (SEBS and SEPS) are the major Kraton polymer structures. The microstructure of SBS consists of domains of polystyrene arranged regularly in a matrix of polybutadiene.

The Kraton polymers used in certain embodiments are FG Kraton, or also known as maleic anhydride (MA) functionalized styrene-ethylene/butylene-styrene. These polymers help produce tough coatings with ductile failure mode and higher processing temperature stability. The two specific polymers used were FG1901 and MD6670.

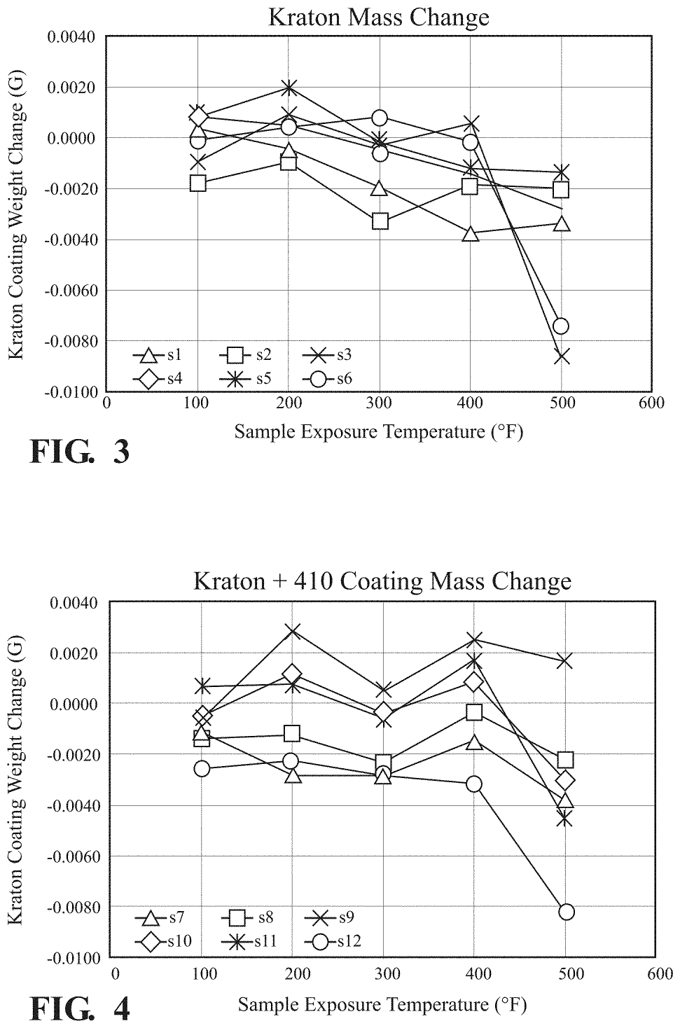

The solvents used for dissolving the Kraton polymer, and for making the coating formulation included, Xylene, MEK and Acetone. The Kraton polymer concentrates of 15-50% by weight was made in Xylene and diluted to final concentrations by selective additions of Xylene, MEK and Acetone. Three concentration of Kraton FG1901 were coated on 2×3-in steel coupons. The coated samples were let dry at room temperature and their mass and coating thickness were measured. Each of the samples was run in duplicate. The samples were heated at 100, 200, 300, 400 and 500° F. for 5 minutes each to determine the optimal thermal cure conditions for just Kraton and in later section we show the same treatments for Kraton with our metallic additives. After each thermal treatment, the sample mass and coating thickness data was taken. The mass data on three solutions including the binder (Kraton) in amounts of 7.5% (s1, s2), 12.5% (s3, s4), and 15% (s5, s6), wherein the remainder of each solution is solvent, is provided in FIG. 3. The mass data on three solutions including the binder (Kraton) in amounts of 7.5% (s7, s8), 12.5% (s9, s10), and 15% (s11, s12), wherein the remainder of each solution is the 410 (40% Zn plus 10% Al—Si) coating described herein, is provided in FIG. 4.

The mass change data of steel samples coated with three different solutions of Kraton FG1901 are plotted as a function of the sample heating temperature in FIG. 3.

Data in FIG. 3 shows that there are mass changes of the coating at exposure temperature above 300° F. and these can be for the higher Kraton concentrations of 12.5 and 15.0%. For the 7.5% solution chosen, changes are minimal even after 500° F. exposure.

The mass change data of steel samples coated with three different solutions of Kraton FG1901 with metallic additives to create 410 coating system are plotted as a function of the sample heating temperature in FIG. 4.

Data in FIG. 4 shows that there are minimal mass changes of the coating at exposure temperatures up to 400° F. However, at 500 degrees F. exposure all samples showed a mass loss with the exception of one sample. The data for the two samples prepared with 7.5% solution showed very consistent behavior and were indicative that the curing beyond room temperature may have minimal changes in coating performance, based just on mass change.

The final coating on the steel for the desired automotive applications may meet the following criteria listed below.

The coating should protect the steel from oxidation during the heat-up temperature of 940° C. for 3-8 minutes in air. These are the steel preheat conditions before the steel is hot stamped in to final shapes.

The second requirement is that the coated steel, before going through the high temperature, should be able to handle the following: shipping from production site to use site, during in plant handling, shearing and other operations. The performance requirement is that coating should not be easily scratched, peeled or damaged to prevent its high temperature performance, stated above.

The third requirement is that the coated and heated steel surfaces should provide aqueous corrosion resistance. This includes normal humid air and salt water.

The fourth requirement is that the coated, and hot stamped steel should be easily weld-able by a range of methods used in assembly of parts in to final components.

In addition to the requirements listed above, the coating should be capable of being applied on steel coils using the current commercial coil coating processes.

Further, ensuring providing a coating process that is more economic and convenient as opposed to the hot dipping process is also a goal or requirement.

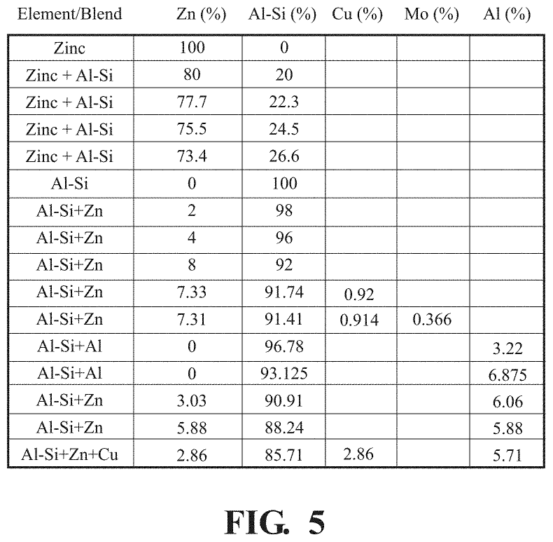

In an attempt to meet most of the coating requirements listed above, this invention focused on various elements and combinations, listed in FIG. 5.

All of the elements used in the blends listed in FIG. 5 were commercially procured powders of particle sizes that were in the range of 5-35 microns. In addition to the chosen elements and their combinations, the loading percent of the powder blend in to the binder system was important. Typical powder loadings experimented ranged from 30-80% with preferred loading of 40-50%. Each of the powder loading was well mixed with the binder system. As described in the previous section, the binder loading of 7.5% in preferred solvent combinations of xylene and acetone were used. The preferred, binder was the Kraton 1901FG. The mixed blends of the powders with the binder system were spray painted on steel samples. Typical samples were 2×3-in with varying thicknesses of 0.030-0.060-in.

The following Table 2 provides example compositions (19-1 to 19-19) which can be used as the top functional layer in the coating. In each case, the sample (metal element or elements) was mixed with a base of the slurry. The base of the slurry was prepared by mixing 7.5 wt % binder (Krayton 1901) with a balance of Xylene and acetone (75:25). For example, in sample 19-1, 40 wt. % Zn was mixed with 60 wt. % of the base (7.5 wt. % binder and 92.5 wt. % binder/xylene/acetone). In the compositions, Zn is pure zinc, and Al—Si is an alloy including 11-13 wt % silicon and a balance of aluminum.

| Sample | Element 1 | Element 2 | |
|---|---|---|---|
| # | (wt. %) | (wt. %) | Final Coating compositions (wt. %) |
| 19-1 | Zn = 40 | | Zn = 100 |
| 19-2 | Zn = 40 | Al—Si = 5 | Zn = 87.5, Al = 11, Si = 1.5 |
| 19-3 | Zn = 40 | Al—Si = 5 | Zn = 87.5, Al = 11, Si = 1.5 |
| 19-4 | Zn = 40 | Al—Si = 5 | Zn = 87.5, Al = 11, Si = 1.5 |
| 19-5 | Zn = 40 | Al—Si = 10 | Zn = 75, Al = 22, Si = 3 |
| 19-6 | Zn = 40 | Al—Si = 10 | Zn = 75, Al = 22, Si = 3 |
| 19-7 | Zn = 40 | Al—Si = 15 | Zn = 62.5, Al = 33, Si = 4.5 |
| 19-8 | Zn = 40 | Al—Si = 15 | Zn = 62.5, Al = 33, Si = 4.5 |
| 19-9 | | Al—Si = 50 | Al = 88, Si = 12 |
| 19-10 | | Al—Si = 50 | Al = 88, Si = 12 |
| 19-11 | Zn = 2 | Al—Si = 50 | Zn = 4, Al = 84.48, Si = 11.52 |
| 19-12 | Zn = 2 | Al—Si = 50 | Zn = 4, Al = 84.48, Si = 11.52 |
| 19-13 | Zn = 4 | Al—Si = 50 | Zn = 8, Al = 80.96, Si = 11.04 |
| 19-14 | Zn = 4 | Al—Si = 50 | Zn = 8, Al = 80.96, Si = 11.04 |
| 19-15 | Zn = 4 | Al—Si = 50 | Zn = 8, Al = 80.96, Si = 11.04 |
| 19-16 | Zn = 4 | Al—Si = 50 | Zn = 8, Al = 80.96, Si = 11.04 |
| 19-17 | Zn = 4 | Al—Si = 50 | Zn = 8, Al = 80.96, Si = 11.04 |
| 19-18 | Zn = 4 | Al—Si = 50 | Zn = 8, Al = 80.96, Si = 11.04 |
| 19-19 | Zn = 4 | Al—Si = 50 | Zn = 8, Al = 80.96, Si = 11.04 |
| 19-20 | Zn = 4 | Al—Si = 50 | Zn = 8, Al = 80.96, Si = 11.04 |

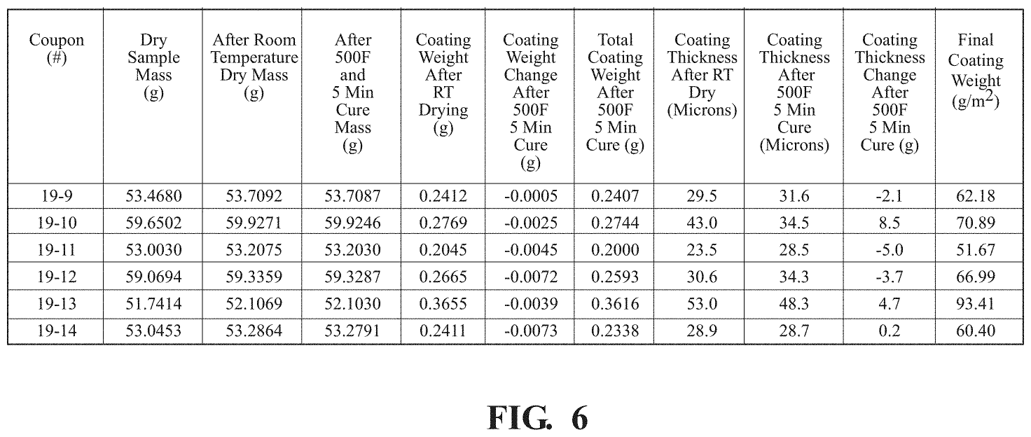

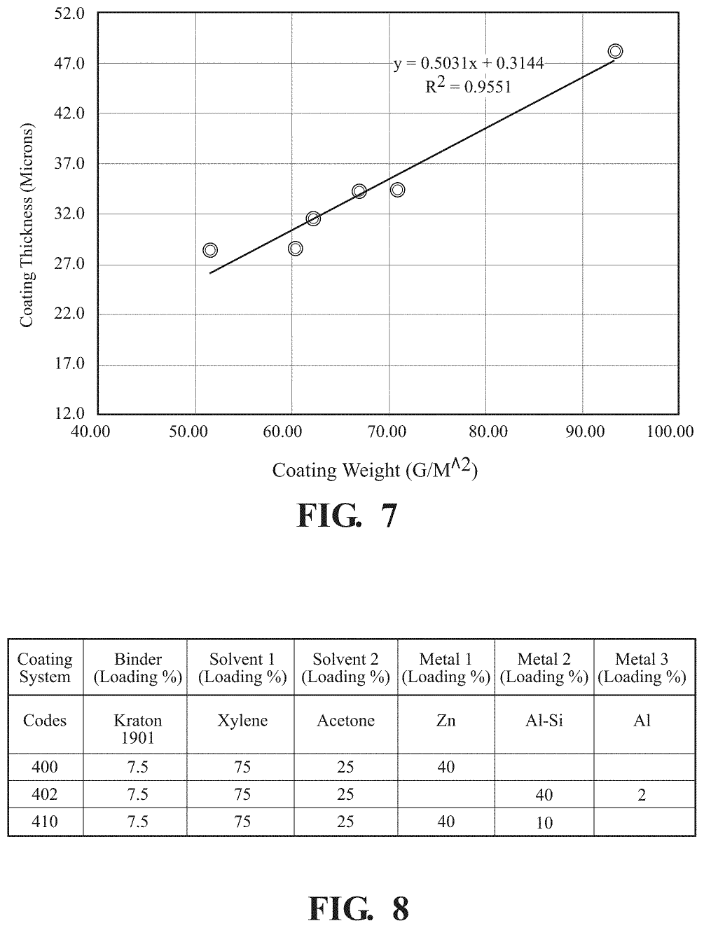

FIG. 6 includes data for compositions 19-9 to 19-14. Data from FIG. 6 is plotted in FIG. 7, to show the correlation of coating thickness with coating weight.

The coating thickness versus coating weight correlations for other coating series than series 19 were similar to series 19, with differences in the coating thickness and coating weight correlations.

### Coating Formulation Examples:

Based on data in FIG. 6 and many coating formulations, three coating systems were focused for detailed testing and analysis. Details of the three chosen systems are summarized in FIG. 8. All of the coating systems, 400, 402 and 410 gave acceptable performance of adhesion to steel and oxidation resistance after 940° C. treatment for 5 minutes. This was true when the steel surface was prepared by simple steps of using scotch bright and degreasing solution. However, when the cleaned surface was activated with zircasil 100 followed by NP-250, the coating system 410 performed extremely well in the following aspects:

Coating adhered uniformly to steel after 940° C. treatment for 5 minutes,

Oxidation of the coating as measured in coating thickness growth was minimal, less than 15%,

Coating is essentially porosity free, and

Coating is repeatable with same response multiple times.

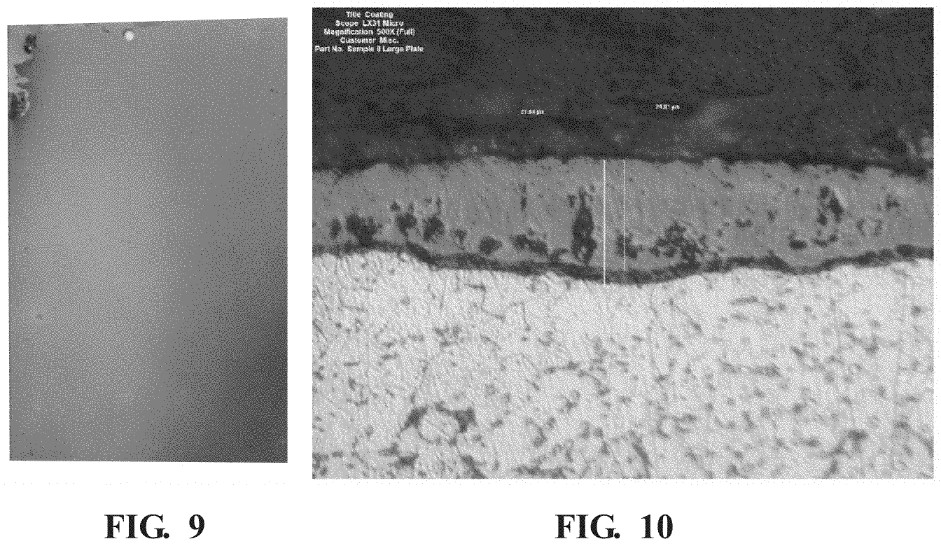

FIG. 9 shows a coated panel, and FIG. 10 shows a detailed microstructure of the coating cross section of a sample component coated with system 410 and surface preparation with zircasil 100 and NP-250.

A closer look at the microstructure in FIG. 10 shows that the 410 coating is 27 microns thick with an interface with steel of about 3 microns. Some non-interconnected porosity is noted in the coating. Since it is not connected and not close to surface, it is considered to be harmless. There may also be a tiny amount of second phase. Overall, the coating is considered to meet most of the requirements set for the coating.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

What is claimed is:

1. A component, comprising:
a substrate formed of steel or steel-based material,
an interfacial layer disposed on said substrate, said interfacial layer including aluminum,
said interfacial layer including at least one intermetallic, and
a top functional layer disposed on said interfacial layer, said top functional layer including at least one of Al, Ni, Fe, Si, B, Mg, Zn, Cr, h-BN, and Mo.

2. The component of claim 1, wherein said at least one intermetallic is selected from the group consisting of: Fe₃Al, FeAl, Fe₂Al₅, and FeAl₂.

3. The component of claim 1, wherein said top functional layer includes Ni, and said at least one intermetallic is selected from the group consisting of NiAl, Ni₃Al, Ni₂Al₃, and NiAl₃.

4. The component of claim 1, wherein said interfacial layer further includes at least one of Si in an amount of 0.5 to 15 wt %, B in an amount of 0.5 to 15 wt %, Mg in an amount of 0.5 to 85 wt %, Zn in an amount of 0.5 to 85 wt %, and Ni in an amount of 0.5 to 85 wt %, based on the total weight of said interfacial layer.

5. The component of claim 1, wherein said interfacial layer is formed by a first slurry which includes at least one of a binder, suspending agent, dispersant, surfactant, and flux agent; and said top functional layer is formed by a second slurry which includes at least one of a binder, suspending agent, dispersant, surfactant, and flux agent.

6. A method of manufacturing a component, comprising the steps of:
applying an interfacial layer to a substrate formed of steel or steel-based material, the interfacial layer being applied as a first slurry containing aluminum in the form of powder,
heating the interfacial layer to a temperature ranging from about 100 to about 600° C. after applying the interfacial layer to the steel substrate,
heating the interfacial layer to a temperature ranging from 600 to 954° C. after heating the interfacial layer to a temperature ranging from about 100 to about 600° C.
applying a top functional layer to the interfacial layer, the top functional layer being applied as a second slurry containing at least one of Al, Ni, Fe, Si, B, Mg, Zn, Cr, h-BN, and Mo in the form of powder,
heating the top functional layer to a temperature ranging from about 100 to about 600° C. after applying the top functional layer to the interfacial layer, and
heating the top functional layer to a temperature ranging from 600 to 954° C. after heating the top functional layer to a temperature ranging from about 100 to about 600° C.

7. The method of claim 6, wherein the step of heating the interfacial layer to a temperature ranging from 600 to 954° C. forms at least one intermetallic in the interfacial layer.

8. The method of claim 7, wherein the at least one intermetallic is selected from the group consisting of: Fe₃Al, FeAl, Fe₂Al₅, FeAl₂, NiAl, Ni₃Al, Ni₂Al₃, and NiAl₃.

9. The method of claim 6, wherein the powders in the interfacial layer and the top functional layer have a particle size of not greater than 100 microns.

10. The method of claim 6, wherein the steps of applying the layers each include at least one of: dipping, brushing, atmosphere plasma spray, vacuum plasma spraying, high velocity spraying (HVOF), flame spraying, wire arc spraying, core wire arc spraying, physical vapor deposition (PVD), and chemical vapor deposition (CVD).

11. The method of claim 6, wherein the first slurry further includes at least one component selected from the group consisting of: a binder, suspending agent, dispersant, solvent, surfactant, and flux agent; and the second slurry further includes at least one component selected from the group consisting of: a binder, suspending agent, dispersant, solvent, surfactant, and flux agent.

12. The method of claim 6 including etching or abrading the substrate to remove oxides from the substrate before applying the interfacial layer to the substrate.

13. The method of claim 12 including removing any grease or oil from the substrate before etching or abrading the substrate, wherein the step of removing any oil or grease from the substrate includes applying a solution including a solvent, alkali, and a surfactant to the substrate, the solvent including at least one of acetone, alcohol, and MEK, the alkali including at least one of NaOH and KOH in an amount of 1 to 5 wt %, based on the total weight of the solution, the solution being at a temperature of 125 to 150° F. when applied to the substrate, and further including the step of removing the solution from the substrate by applying water at a temperature of 125 to 175° F. to the substrate and removing water from the substrate before applying the interfacial layer.

14. The method of claim 6 further including quenching the substrate after the heating steps, and forming the substrate after the quenching step, the forming step including hot or cold stamping.

15. The method of claim 7, wherein the top functional layer includes Ni, and the at least one intermetallic is selected from the group consisting of NiAl, Ni₃Al, Ni₂Al₃, and NiAl₃.

16. The component of claim 1, wherein said interfacial layer includes Zn and Si.

17. The component of claim 1, wherein a total amount of intermetallics present in said coating, including said at least one intermetallic of said interfacial layer, ranges from 2 wt % to 7 wt %, based on the total weight of said coating.

18. The component of claim 4, wherein said interfacial layer includes the B in an amount of 0.5 to 15 wt %, based on the total weight of said interfacial layer.

19. The method of claim 11, wherein all powder formed of metal present in the first slurry, including the aluminum powder, has a particle size ranging from 2 to 7 microns.

20. The method of claim 11, wherein the first slurry includes the binder in an amount of 5 wt % to 15 wt %, based on the total weight of the first slurry.
